(19) United States
(12) Patent Application Publication
(10) Pub. No.: US 2026/0078032 A1
(43) Pub. Date: Mar. 19, 2026

(54) A CYCLIC PROCESS FOR THE EFFICIENT GENERATION OF CHLORINE DIOXIDE IN DILUTE SOLUTIONS

(71) Applicant: Truox, Inc., Naples, FL (US)

(72) Inventor: Roy W. Martin, Naples, FL (US)

(21) Appl. No.: 18/888,837

(22) Filed: Sep. 18, 2024

(51) Int. Cl. C02F 1/76; C01B 11/02; C02F 103/02

(52) U.S. Cl. CPC C02F 1/76; C01B 11/024; C02F 2103/023; C02F 2209/29; C02F 2209/40; C02F 2301/046; C02F 2303/04

(57) ABSTRACT

An efficient cyclic process and related method for the in-situ generation of chlorine dioxide from dilute solutions of chlorite anions in open recirculating systems under alkaline pH conditions. The cyclic process provides enhanced inactivation of microbiological organisms while significantly reducing cost and improving safety.

### FIELD OF INVENTION

This invention relates to a cyclic process for the inactivation of microbiological organisms in aqueous solutions comprising open recirculating systems (e.g. cooling towers, cooling ponds etc.). The process occurs under alkaline pH conditions.

### BACKGROUND

Water is used to extract heat from buildings and industrial applications using cooling towers and/or cooling ponds. The water is treated with scale and corrosion inhibitors to maintain efficient heat transfer as well as extend the life of the equipment. One method of inhibiting corrosion is to operate the water treatment program under alkaline pH conditions and treat the water to inhibit scale formation. The water using this form of treatment typically exceeds a pH of greater than 8.0.

With a pH above 8.0, oxidizing biocides exemplified by free chlorine and free bromine have reduced biocidal efficacy. As a result, the potential for proliferation of bacteria such as Legionella is increased. The biocides performance is further compromised by the formation of biofilms which shelter the colonizing bacteria (i.e Legionella) from exposure to the biocide.

To compensate for these limitations, expensive non-oxidizing biocide are often substituted for the oxidizing biocide and/or are used in combination with oxidizing biocides to provide more effective biocidal treatment which further increases cost.

The most common cause of Legionella illness is the freshwater species L. pneumophila which is found in natural aquatic environments worldwide. However, artificial water systems which provide environments conducive to the growth and dissemination of Legionella represent the most likely sources of disease.

The bacteria live and grow in water systems at temperatures of 20 to 50 degrees Celsius (optimal 35 degrees Celsius). Legionella can survive and grow as parasites within free-living protozoa and within biofilms which develop in water systems. They can cause infections by infecting human cells using a similar mechanism to that used to infect protozoa.

The most common form of transmission of Legionella is inhalation of contaminated aerosols inherent to cooling towers.

The identified incidence of Legionnaires' disease varies widely according to the level of surveillance and reporting. Since many countries lack appropriate methods of diagnosing the infection or sufficient surveillance systems, the rate of occurrence is unknown. However, in the USA there are between 3500 to 5000 cases detected per year.

Prevention of Legionnaires' disease depends on applying control measures to minimize the growth of Legionella and dissemination of aerosols. These measures include good maintenance of devices, including regular cleaning and disinfection and applying other physical (temperature) or chemical measures (biocide) to minimize growth.

Chlorine dioxide has been proven very effective at inactivating microbiological organisms in such applications. Chlorine dioxide maintains a high level of biocidal efficacy in alkaline pH conditions and is very effective at penetrating biofilms to kill the bacteria (i.e. Legionella) underneath.

Chlorine dioxide is typically produced in a chlorine dioxide generator where either acid and/or chlorine are combined with a chlorite donor to generate chlorine dioxide. In order to achieve efficient conversion of chlorite to chlorine dioxide, high concentrations are reacted thereby generating a high concentration of gas which is potentially dangerous.

Chlorine dioxide is also produced by forming tablets from reactive components such as dichloroisocynauric acid, sodium chlorite and an acid source. These also have limitations and also have the concern of producing chlorine dioxide gas premature to the application due to exposure to relative humidity. Tablets are effective when treating a small volume of water such as in survival situations. However, when trying to treat 20,000 gallons of water in a cooling tower and applying an effective amount of chlorine dioxide, the cost is prohibitive.

Regardless of these efforts to efficiently and safely produce chlorine dioxide, the efficiency of chlorite conversion from tablets is commonly less than 70%, and the hazards of producing concentrated solutions remains. In the case of reacting liquid forms of acid and sodium chlorite, the low pH of the solution requires neutralization.

Using these methods of chlorine dioxide generation also waste considerable amounts of reagents such as chlorite as well as elevate cost due to the inability to regenerate the chlorite ions that result from the reduction of the chlorine dioxide back to chlorite or the residual chlorite that was not activated during the initial formation of chlorine dioxide. Both ex-situ generation devices and tablets significantly increase cost and limit accessibility for wide spread use in the cooling tower market place.

There is a need for a safe and efficient method for generating chlorine dioxide for the treatment of cooling water under alkaline pH conditions that is easy to apply and low cost. These unique features and benefits allow for routine (i.e. daily) application of the chlorine dioxide ensuring inactivation of microbiological organisms including those that may be protected by existing biofilms.

U.S. Pat. Nos. 7,922,933, 7,927,509 and 7,976,725 disclose a cyclic process for the in-situ generation of chlorine dioxide. The process is limited to a pH of no greater than 8.5. Furthermore, the process disclosed in the referenced patents requires sustaining a residual of bromide anion in the water ranging from 5 ppm to 1000 ppm thereby further increasing cost.

U.S. Pat. No. 5,603,840 comprises adding bromide to a cooling water system containing corrosion and scale control treatment chemicals at elevated concentrations (40 ppm or greater). A fraction of the recirculating water is drawn off in a side stream and ozonated. Ozone oxidizes bromide to bromine which then serves as a biocide. The bromide levels are chosen such that the ozone/bromide reaction is preferred over the ozone/treatment chemical reaction. Thus, the addition of bromide at elevated concentrations, while acting as a biocide precursor, serves to protect treatment chemicals necessary for corrosion and scale control.

U.S. Pat. No. 10,427,959 discloses a system producing safe, self-limiting concentrations of chlorine dioxide for treating process water exemplified by open recirculating systems (i.e. cooling towers).

Publication No. WO2007/078838 A2 discloses a solid composition comprising a solid source of hypobromous acid and a solid source of chlorite to produce chlorine dioxide. The composition has a pH of 5-9 at 25° C. when dissolved at a concentration of 1 gram per 100 ml water. Publication No. US20030080317 discloses a massive body that uses chlorine, an acid and chlorite to produce chlorine dioxide.

U.S. Pat. No. 6,303,038 discloses a water soluble dialkylhydantoin and a source of bromide ion are added to a body of water needing sanitization. This is followed by contacting the body of water with an oxidizing agent, which creates biocidal species in situ in the body of water.

### SUMMARY OF THE INVENTION

Surprisingly and unexpectedly, it has been observed that in-situ generation of chlorine dioxide can be efficiently achieved at a pH greater than 8.5 using the invention. Furthermore, the invention does not require sustaining bromide anion concentration of at least 5 ppm to achieve the desired in-situ generation of chlorine dioxide in open recirculating systems.

The cyclic process substantially reduces the cost of chlorine dioxide treatment compared to using tablets or generators since the surrogate anion of chlorine dioxide (chlorite anion) is regenerated in the cyclic process back to chlorine dioxide. This cyclic process continues until either the chlorite anion or activating free halogen is depleted. Furthermore, by eliminating the need for sustaining high bromide anions in the water, the disclosed invention further reduces chemical use and associated cost while being effective at killing legionella in open recirculating systems.

It has been discovered that the cyclic process provides a means for in-situ generation of chlorine dioxide from dilute chlorite anion solutions under alkaline pH conditions that was believed to be detrimental to generating chlorine dioxide.

The disclosed invention is based on the discovery that efficient in-situ generation of chlorine dioxide occurs at low concentrations of chlorite anions under alkaline pH conditions when reacted with selective activating free halogens.

Activating free halogens effective for the activation of chlorite anions under alkaline pH conditions include free bromine and free iodine. Free Bromine under alkaline pH conditions comprises hypobromous acid (HOBr) and hypobromite anion (OBr⁻). Free iodine is generally represented by iodine (I₂) and hypoiodous acid (HIO). With respect to iodine other surrogate species may be present such as hypoiodite anion (OI⁻), iodide (I⁻), triiodide (I₃⁻) and iodate (IO₃⁻) depending on the pH and conditions (i.e. presence of other oxidants like chlorine).

Activating free halogens result from hydrolysis of free halogen donors and/or by oxidation of their respective surrogate anion “halide” species (e.g. bromide anion and iodide anion).

Non-limiting examples of activating free halogen donors include: 1,3-dibromo-5,5-dimethylhydantoin (DBDMH), 1,3-bromo-chloro-5,5-dimethylhydantoin (BCDMH), 1,3-dichloro-5,5-dimethylhydantoin (DCDMH), 1,3-dichloro-5-ethyl-5-methylhydantoin, mixtures of chlorinated isocyanuric acid and sodium bromide (i.e. Towerbrom® sold by Oxychem), bromine monochloride, sodium hypochlorite, lithium hypochlorite, dichloroisocyanuric acid, trichlorisocyanuric acid and iodine.

Activating free halogens can also be produced by oxidation of bromide donors and/or iodide donors. Preferred non-limiting examples of bromide donors include sodium bromide, lithium bromide and potassium bromide. Preferred non-limiting examples of iodide donors include sodium iodide and potassium iodide.

Oxidation of bromine and/or iodide anions can be accomplished with oxidizers such as chlorine donors, ozone, persulfate donors, potassium monopersulfate or by electrolysis. These methods of oxidation can be applied to produce activating free halogens as well as reactivation of surrogate anion resulting from reduction of their respective activating free halogen. Oxidizers such as chlorine donors or persulfates donors can be applied in excess to sustain a residual oxidant in the aqueous solution of the open recirculating system during the cyclic process. As the activating free halogen is reduced to its surrogate anions (e.g. bromide and/or iodide), the residual oxidant reactivates (oxidizes) the surrogate anions back to the activating free halogen.

Solid reactive free halogen donors can be in the form of powder, granules, nuggets, tablets or any convenient geometric configuration.

Efficient regeneration of chlorite anions under alkaline pH opens the pathway for sustaining a cyclic process resulting in recycling of substantially inert anions into powerful and effective oxidants and disinfectants. The cyclic process is achieved by sustaining an effective amount of activating free halogen in the presence of chlorite anions. Of tremendous benefit is the ability to cost effectively and safely produce chlorine dioxide without the need for combining active ingredients such as in the case of a solid tablet, or generating high concentrations such as in the case of on-site generators. The toxic nature or chlorine dioxide as well as its potential explosive properties in high concentration make it very advantageous to efficiently produce chlorine dioxide in-situ using dilute solution of the reactants.

### BRIEF DESCRIPTION OF THE DRAWINGS

FIG. 1 is a non-limiting illustration of the cyclic process where the activating oxidizer free halogen is applied or sustained at a rate sufficient to achieve the desired residual of hypobromous acid (HOBr). The HOBr reacts with chlorite anion (ClO₂—) resulting in the production of chlorine dioxide (ClO₂) and reduction of HOBr to Br—. The bromide (Br—) can be reactivated with addition of oxidizers (i.e. chlorine). Chlorine dioxide reacts with active microbiological organism (MB_{ACTIVE}) resulting in reduction of the chlorine dioxide back to chlorite anion and inactive microbiological organism (MB_{INACTIVE}). Since the chlorite anion is converted to chlorine dioxide as long a sufficient residual of hypobromous acid (activating free halogen) exist, the amount of chlorite donor required to achieve the desired biocidal effect is greatly reduced compared to ex-situ generation and application of chlorine dioxide.

FIG. 2 illustrates the chlorine dioxide generation and accumulation using the cyclic process. The chlorine dioxide concentration was measured using an on-line monitor fitted with a gas permeable membrane on a lissamine green calibrated amperometric sensor. A 46,000 gallon circulating system was treated with 0.2 lbs of 25 wt % active NaClO₂ per 10,000 gallons water (equivalent to 0.44 ppm as ClO₂⁻). The low concentration of chlorite anion provided enough chlorine dioxide using the cyclic process to exceed a Ct value of over 137 (mg·min)/liter before the test was concluded. The Ct value obtained from the recorded data is equivalent to sustaining 1.0 ppm of chlorine dioxide for over 137 minutes. As can be seen from the figure, the actual Ct value achieved would have been far greater had the test been able to continue until the chlorite anion was effectively depleted.

FIG. 3 illustrates a non-limiting example of a system for implementing the cyclic process to an open recirculating system.
(1) Represents a vessel for holding a free halogen donor
(2) Represents a solid form of free halogen donor (i.e. Towerbrom® 90)
(3) Water inlet
(4) Aqueous solution of activating free halogen outlet
(5) Chlorite donor injection
(6) Cooling tower basin

### DETAILED DESCRIPTION OF THE INVENTION

The following terms will be used throughout the specification and will have the following meanings unless otherwise indicated.

“A” or “an” means “at least one” or “one or more” unless otherwise indicated. As used herein “multi-” or “plurality” refers to 2 or more.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

When referring to a group, “at least one . . . and . . . ” in the specification and claims is synonymous with “and/or”. For example, “at least one of A, B and C” means A alone, B alone, C alone, or any combination of A, B or C.

### Definitions

Various compositions and methods of the invention are described below. Although particular compositions and methods are exemplified herein, it is understood that any of a number of alternative compositions and methods are applicable and suitable for use in practicing the invention.

As used herein, “free halogen donor” is used with reference to a halogen source which acts as an oxidizer when dissolved in water and is used to either directly or indirectly produce an activating free halogen. Chlorine based free halogen donors form at least one of Cl₂, HOCl, and OCI⁻ (also referred to as free chlorine) when added to water, whereby the species formed is pH dependent. Bromine based free halogen donors form at least one of Br₂, HOBr, and OBr (also referred to as free bromine), again the species being pH dependent.

As used herein, “activating free halogen” describes an oxidizer capable of activating chlorite anion under alkaline pH conditions. Activating free halogens are selected from at least one of free bromine and/or free iodine.

As used herein, “effective amount of activating free halogen” describes applying a supra-stoichiometric concentration of activating free halogen to generate chlorine dioxide and support the cyclic process in the open recirculating system to achieve enhanced inactivation of microbiological organisms. One mole of activating free halogen can activate 2 moles of chlorite anion to produce chlorine dioxide. A supra-stoichiometric concentration of activating free halogen applies greater than 1 mole of free halogen for every 2 moles of chlorite resulting in a residual of activating free halogen to support the cyclic process in the water of the open recirculating system. The residual of activating free halogen in the water of the open recirculating system ranges from about 0.2 to 10 ppm reported as Cl₂.

As used herein, “free iodine” describes the forms of iodine comprising iodine (I₂) and hypoiodous acid (HIO) resulting under alkaline pH conditions and associated with activation of chlorite anion to chlorine dioxide. The ratio of iodine to hypoiodous acid is pH dependent.

As used herein, “free bromine” describes the hydrolyzed form of bromine comprising hypobromous acid (HOBr) and hypobromite ions (OBr) resulting under alkaline pH conditions and associated with activation of chlorite anion to chlorine dioxide. The ratio of hypobromous acid to hypobromite ions is pH dependent.

As used herein, “free chlorine” describes the hydrolyzed form of chlorine comprising hypochlorous acid (HOCl) and hypochlorite ions (OCI⁻). The ratio of hypochlorous acid to hypochlorite ions is pH dependent.

As used herein, “dilute solution of chlorite anion” describes the aqueous system comprising no more than about 100 ppm chlorite anion reported as ClO₂⁻.

As used herein, “alkaline pH” describes the pH of an aqueous system of greater than 8.0 and less than 10.0, more preferred greater than 8.5 and less than 9.8.

As used herein, “effective amount of chlorite anions” describes the amount of chlorite anion required to achieve from 0.1 to 5 ppm as ClO₂ in the water of the open recirculating system and achieve enhanced inactivation of microbiological organisms using the cyclic process.

As used herein, “effective amount of free bromine” is the concentration of free bromine in the water to drive the cyclic process. The effective amount of free bromine ranges from about 0.2 ppm to 5 ppm, more preferred 0.3 ppm to 4 ppm and most preferred 0.5 to 3 ppm as free bromine.

As used herein “chlorite donor” comprises a source of chlorite anion that can be activated using the cyclic process. Non-limiting examples of chlorite donors include: chlorine dioxide, alkali metal chlorite (i.e. sodium chlorite), alkali earth metal chlorite (i.e. calcium chlorite). Chlorine dioxide can indirectly produce chlorite anions due to reduction in an aqueous system. Sodium chlorite directly supplies chlorite anions. Regardless of whether the chlorite anion is provided by a direct or indirect chlorite anion donor, any chlorite anion in the aqueous system implementing the cyclic process of the invention will be regenerated to chlorine dioxide in the cyclic process.

As used herein, the term “chlorite anion” comprises chlorite having the general formula ClO₂⁻.

As used herein, “biocidal effect” describes the application of the cyclic process to produce chlorine dioxide to achieve desired reduction in measured microbiological activity and/or a targeted Ct value.

As used herein, “measured microbiological activity” describes semi-quantitative and/or quantitative test methods to determine the relative microbiological activity (i.e. colonies/ml) in the aqueous solution of an open recirculating system.

As used herein, “Ct value” is defined by the equation:

$$Chlorine dioxide Ct value ( mg \cdot min / liter = Concentration of {ClO}_{2} ( mg / liter ) \times Time ( minutes )$$

As used herein, “inactivation” is used with reference to the ability to kill or destroy a microbiological organism exemplified by legionella.

As used herein, “enhanced inactivation” also “enhancing inactivation” describes the increased inactivation of (reduction in living) microbiological organisms including waterborne pathogens (i.e. legionella) using the cyclic process when compared to an equivalent concentration of chlorine dioxide based on the concentration of chlorite anion applied to the open recirculating system. Enhanced inactivation is achieved as a result of the cyclic process driving in-situ activation of residual chlorite to chlorine dioxide. When chlorine dioxide is reduced, a portion will revert to chlorite, which is then reactivated by free bromine or iodine to chlorine dioxide maximizing the biocidal efficiency of the chlorite.

As used herein, “microbiological organisms” describes all forms of microbiological life including: parasites, bacteria, viruses, algae, fungus, and said organisms encased in biofilms.

As used herein, “remediation of legionella” describes achieving a 6-log reduction of legionella in the water of the open recirculating system.

As used herein, “oxidizer” is used to describe chlorine donors, persulfate donors or ozone-based oxidizers capable of producing activating free halogen from either bromide anions and/or iodide anions. The “oxidizer” can be used as a residual oxidant in the aqueous solution of the open recirculating system to “reactivate” bromide and/or iodide that had been reduced while supporting the cyclic process.

As used herein, “flowing water through a system” describes equipment in fluid contact used to produce an aqueous solution comprising the activating free halogen and chlorite anions to produce chlorine dioxide. Non-limiting examples of equipment may include: piping, tubing, vessels, tanks, valves, chemical pumps, venturis and the like.

As used herein, “Persulfate donor” includes potassium persulfate, sodium persulfate, ammonium persulfate, and potassium monopersulfate.

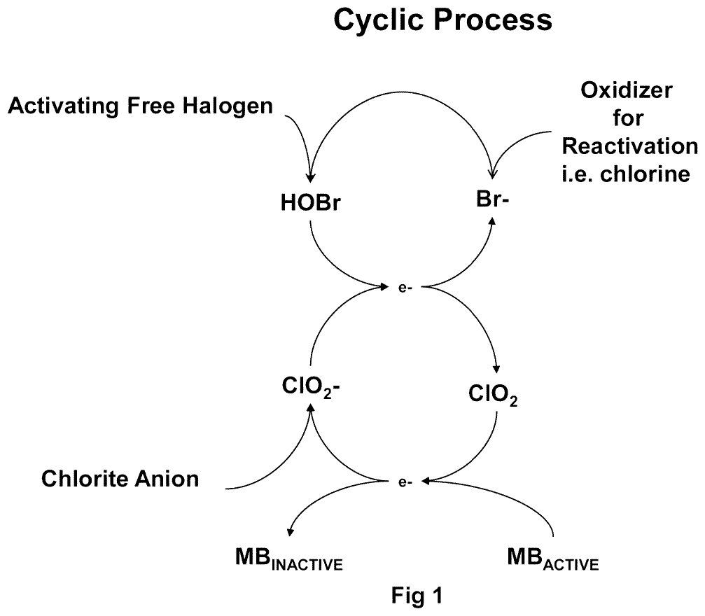

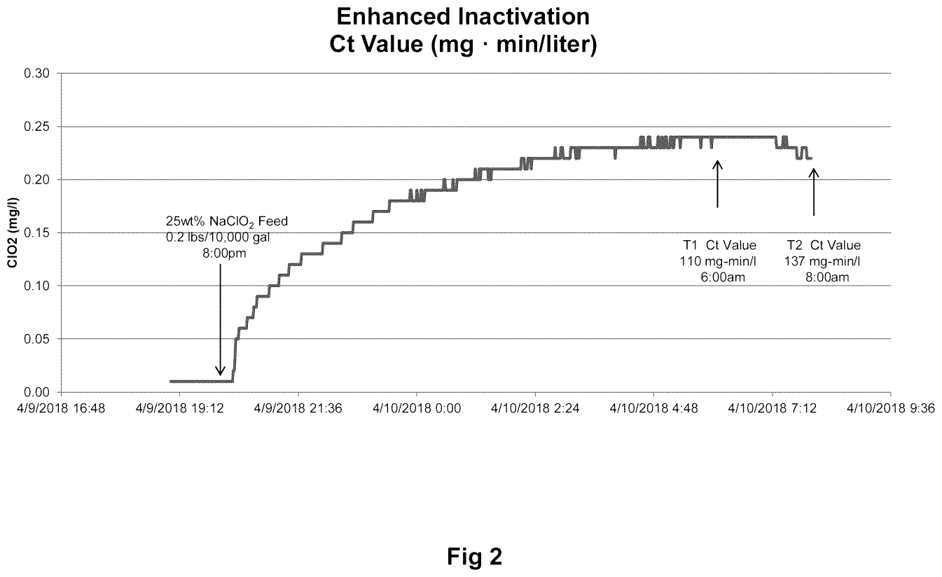

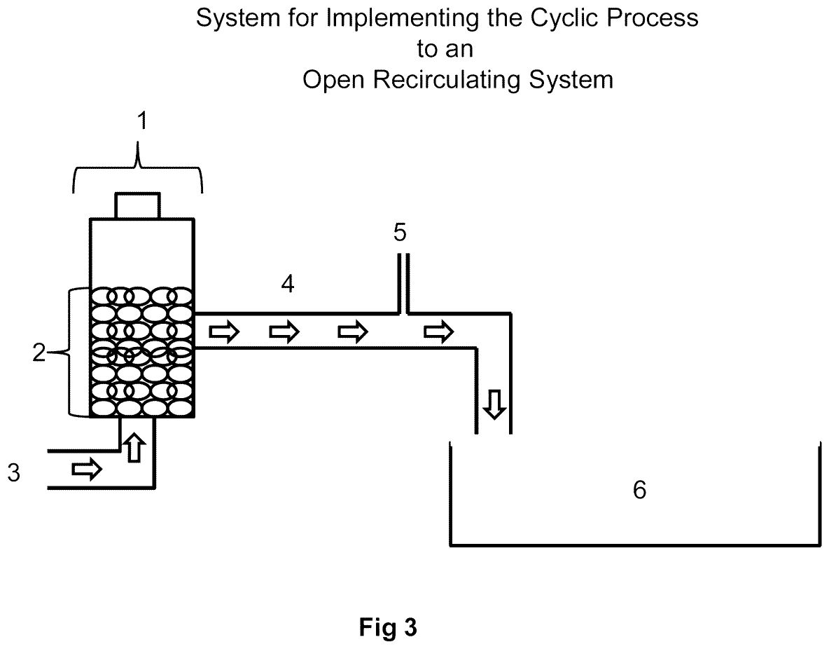

As used herein, the term “cyclic process” relates to the recycling of substantially inert chlorite anions back to chlorine dioxide. The cyclic process can further be extended to include converting bromide and/or iodide back to their respective active free halogen using residual oxidizer. FIG. 1 exemplifies the cyclic process which increases the cost effectiveness of the chlorite treatment and increases biocidal efficacy by enhancing inactivation of microbiological organisms such as legionella.

As used herein, the term “open recirculating system” describes a water system that circulates cooled water from a reservoir through a piping system to extract heat from a process (i.e. heat exchangers), cools the water using evaporative cooling, and returns the cooled water to the reservoir. Examples of open recirculating system include cooling retention ponds and cooling towers.

As used herein, the term “cooling tower” represents an open recirculating system having a tower that forms fine water droplets and exposing them to flowing air to remove latent heat by means of evaporation.

As used herein, “blowdown” describes the process of removing water from the cooling tower or cooling pond in order to lower the dissolved solids. As water evaporates to cool the water, the minerals (e.g. calcium, magnesium etc.) remain behind and concentrate. The concentration of minerals combined with increasing alkalinity (i.e. carbonate (CO₃═) can stress the scale inhibitor treatment and scale the heat exchangers resulting in poor heat transfer as well as induce under deposit corrosion. Blowdown is used as a means to control dissolved solids.

### DETAILED DESCRIPTION OF THE EMBODIMENT(S)

In a first embodiment, it has been discovered that the cyclic process provides a means for in-situ generation of chlorine dioxide from dilute chlorite anion solutions under alkaline pH conditions that was believed to be detrimental to generating chlorine dioxide.

In a second embodiment, the invention comprises a cyclic process that provides enhanced inactivation of microbiological organisms. As used herein, “enhanced inactivation” describes the increased inactivation achieved using the cyclic process when compared to an equivalent amount of chlorine dioxide applied using ex-situ generation and based on the same concentration of chlorite anions applied to the open recirculating system.

In a third embodiment, the invention discloses a method for implementing the cyclic process to an open recirculating system to achieve enhanced inactivation of microbiological organisms, the method comprising:
flowing water through a system in fluid contact with the open recirculating system that produces an aqueous solution comprising an effective amount of activating free halogen and an effective amount of chlorite anions;
passing the aqueous solution through a conduit to produce a chlorine dioxide solution; and
applying the chlorine dioxide solution to an open recirculating system;
wherein the pH of the water in the open recirculating system ranges from about 8 to 10, and
wherein at least some portion of the recovered chlorite anions resulting from the reduction of chlorine dioxide are reactivated with activating free halogen to chlorine dioxide resulting in enhanced inactivation of microbiological organisms.

In accordance with the third embodiment, wherein the pH of the water in the open recirculating system ranges from about 8.5 to 10.

In accordance with the third embodiment, wherein the activating free halogen is produced by reactions between a chlorinated isocyanurate and bromide salt.

In accordance with the third embodiment, wherein the activating free halogen is produced using Towerbrom® 90M.

In accordance with the third embodiment, wherein the activating free halogen is produced using Towerbrom® 60M.

In accordance with the third embodiment, wherein the effective amount of activating free halogen is sufficient to sustain the cyclic process until the chlorine dioxide has achieved the desired biocidal effect.

In accordance with the third embodiment, wherein desired biocidal effect is remediation of legionella.

In accordance with the third embodiment, the effective amount of chlorite anion is sufficient to achieve a targeted Ct value.

In the fourth embodiment, a system for implementing the cyclic process to an open recirculating system to achieve enhanced inactivation of microbiological organisms under alkaline pH conditions, the system comprising:
flowing water through a conduit in fluid contact with a vessel containing a composition comprising a chlorinated isocyanurate and bromide salt to produce an aqueous solution having an effective amount of activating free halogen;
adding to said aqueous solution an effective amount of chlorite anions to produce a chlorine dioxide solution;
applying the chlorine dioxide solution to the water in an open recirculating system; the water having a pH from about 8 to 10; and
wherein at least some portion of the chlorite anions resulting from the reduction of chlorine dioxide reacts with residual activating free halogen to in-situ generate chlorine dioxide resulting in enhanced inactivation of microbiological organisms.

In accordance with the fourth embodiment, the water in the open recirculating system having a pH of about 8.5 to 10.

In the fifth embodiment, a method for implementing the cyclic process to an open recirculating system to achieve enhanced inactivation of microbiological organisms under alkaline pH conditions, the method comprising:
applying to the water of the open recirculating system an effective amount of activating free halogen and an effective amount of chlorite anions;
the water having a pH from about 8 to 10;
the activating free halogen and chlorite anions react to in-situ generate chlorine dioxide, and
wherein at least some portion of the chlorite anions resulting from the reduction of chlorine dioxide reacts with residual activating free halogen to in-situ generate chlorine dioxide resulting in enhanced inactivation of microbiological organisms.

The invention in accordance with the fifth embodiment, wherein the pH of the water ranges from about 8.5 to 10.

To illustrate the features and benefits of “enhanced inactivation” when chlorine dioxide is reduced, approximately 85 percent is reduced back to chlorite anions. Using the cyclic process, over time the 85 percent of the chlorite is reactivated back to chlorine dioxide. This process repeats itself until the chlorite anion is effectively depleted.

If 1.0 ppm of chlorine dioxide is applied to an open recirculating system, once depleted more chlorine dioxide needs to be generated and applied to the system. When comparing to the cyclic process against 1.0 ppm of chlorine dioxide (equivalent to 1 ppm as chlorite anion) the cyclic process results in the following equivalent chlorine dioxide reported as ppm ClO₂: 1.0+0.85+0.72+0.61+0.52+0.44+0.37+0.32+0.27+0.23+0.19+0.16+0.14+0.12+0.10≥6.00 ppm as ClO₂ equivalence.

By applying a chlorite anion donor to achieve 1.0 ppm of chlorite anion, the result is equivalent to approximately 6.0 ppm of ClO₂. A six-fold increase in the inactivation capacity compared to ex-situ generated chlorine dioxide resulting in enhanced inactivation using the same initial concentration of chlorite.

In the following discussion bromine donor is used for exemplary purposes only and is not meant to limit the sources of activating free halogen to only bromine.

Activated free halogen can be provided directly from free bromine donors such as dibromo-dimethyl-hydantoin (DBDMH), bromo-chloro-dimethy-lhydantoin (BCDMH) and other free bromine donors stabilized with hydantoin, cyanuric acid, and the like.

Other alternatives include applying a bromide donor (bromide salt) such as sodium bromide with a source of chlorine such as liquid bleach or using a solid source of chlorine such as trichloroisocyanuric acid. Further still, a blended product that contains both bromide donor and chlorine can be used to produce a bromine based activating free halogen as well as provide residual free chlorine to be used to reactivate the bromine anion resulting from the reduction of the hypobromous acid during the cyclic process. One example of a commercially available blended product is Towerbrom® sold by OxyChem headquartered in Dallas Texas.

The cyclic process disclosed also allows for efficient use of reagents by utilizing a process control system to monitor and regulate the feed of the various reagents. For example, oxidation reduction potential (ORP) can be used to feed the oxidizer such as a free chlorine donor to reactivate the surrogate bromide and/or iodide anions. An amperometric sensor or automated titration methods can be employed to monitor free halogen concentration and/or chlorine dioxide. While many variations can be derived, the technology for a process control system is available. Additional algorithms, time based proportional control, time-based feed and the like can be incorporated into the program logic to enhance optimization of the feed of chemicals to optimize the biocidal effect resulting from of the cyclic process.

### Application and Control

The disclosed invention is a cyclic process for the enhanced inactivation of microbiological organisms in an open recirculating system under alkaline pH conditions.

The cyclic process provides a means of enhanced inactivation as a result of achieving a reduction in microbiological activity (i.e. legionella) compared to an equivalent concentration of chlorine dioxide based on the chlorite anion concentration applied to the open recirculating system.

The cyclic process uses an effective amount of an activating free halogen ranging from 0.2 ppm to 20 ppm reported as Cl₂, more preferred 0.3 ppm to 10 ppm reported as Cl₂, and most preferred 0.4 ppm to 5 ppm reported as Cl₂.

Due to the high losses of water from cooling tower “blowdown” it is not desirable to maintain high concentration of halides (e.g. bromide and/or iodide) that can be converted to activating free halogen by activation with an oxidizer. Instead, it is preferred to operate with an effective amount of activating free halogen (i.e. 0.20 ppm to 5 ppm reported as Cl₂) to reduce chemical cost yet efficiently drive the cyclic process. At 5 ppm HOBr, the bromide concentration is less than 5 ppm as Br-which was previously thought to be the minimum required concentration of bromide anions as described in the referenced prior art U.S. Pat. No. 7,927,509. The high expense associated with bromide and iodide coupled with the high rate of water losses from a cooling tower system makes sustaining high concentrations of halides unfavorable.

Furthermore, only low concentrations of activating free halogen are required if the cyclic process is to be sustained daily from about 3 to 24 hours, for example maintaining only 0.01 ppm (10 ppb) of chlorine dioxide provides a Ct value of 14.4 mg·min/liter over a 24 hour period.

Furthermore, it only takes 1 mole of activating free halogen to activate 2 moles of chlorite anion. If low Ct values are required, then only an initial low dose of activating free halogen is required to produce enough chlorine dioxide to meet or exceed the targeted biocidal effect. However, if a higher Ct value is required, then providing a residual oxidant will result in reactivating the halides of bromide and/or iodide to sustain the activating free halogen so the cyclic process can continue.

The amount of chlorite anion required to provide an effective amount of chlorite anion is dependent on the specific needs of the application. Heavy fouled system may need to feed high concentrations of chlorite anions over an extended period of time to clean the system (high Ct value). However, without being restricted to an amount or concentration of chlorite anions, it is expected the concentration of chlorite anions will be sufficient to result in a chlorine dioxide concentration from about 0.01 ppm to 10 ppm reported as ClO₂.

The cyclic process can be sustained to achieve a desired Ct value to ensure biocidal effect is met. The ideal Ct value is dependent of the needs of the application taking into consideration the starting conditions, level of contamination in the water from either poor makeup water quality or process leaks etc. If using the cyclic process is continuous, the Ct value is effectively never ending. With that understood, to maintain the microbiological activity in clean open recirculating system, it is desirable to achieve a Ct value of greater than 1.

In the cyclic process, especially during intermittent feeds where higher concentrations of chlorine dioxide are targeted to achieve a high Ct value in a relatively short period of time, it is beneficial to provide an oxidant to reactivate the halides of the activating free halogen back to their respective active form. One preferred oxidant is free chlorine which can reactivate the halide back to activating free halogen. The low cost of free chlorine reduces the treatment cost by limiting the addition of more expensive bromine and/or iodine or their surrogate halides. As a result the cyclic process can be carried out for an extended period of time while keeping the halide anions (i.e. bromide) at low concentrations (i.e. <5 ppm as Br—) even when higher concentrations of activating free halogen are applied (e.g 20 ppm HOBr &/or HIO).

One example of preferred products for providing activating free halogen and residual oxidant is Towerbrom® 90M and Towerbrom® 60M from Oxychem. The products comprise sodium bromide (NaBr) with the remaining being predominately trichloroisocyanuric acid or dichloroisocyanurate respectively. In many applications, less than 1 ppm as Bromide (Br—) is needed to drive the cyclic process as the excess residual of free chlorine will quickly reactivate the bromide as the hypobromous acid is reduced activating the chlorite anions using the cyclic process.

Yet another example is the use of Bromochlorodimethylhydantoin (BCDMH) which delivers both free bromine and free chlorine.

While control of all common microbiological organisms common to cooling tower is the objective in order to alleviate and then prevent fouling and corrosion, of particular interest is the inactivation of Legionella.

Systems for applying the cyclic process can be as basic as manually dumping the needed chemicals into the cooling tower basin (reservoir). However, the use of automation for feeding chemicals is common place and removes the hazards of handling the chemicals.

FIG. 3 is a non-limiting example of a system that can be used to implement the cyclic process while initiating at least some of the chlorite anions into chlorine dioxide to accelerate the inactivation of microbiological organisms. The illustration is non-limiting in that any number of chemical feed system and be employed to do very much the same thing or provide a desirable variation.

For example, the vessel can be a pressurized vessel for holding solid BCDMH, or a tank for holding liquid bleach or bromine monochloride. Chemical pumps can be used to inject liquid chemicals into a manifold through which cooling tower water or makeup water passes. A venture (Mazzei) can be inserted into the water line so when water flows, a vacuum is created and liquid chemical is sucked into the water line where chlorine dioxide can begin to generate. For example, referring to FIG. 3, (5) on the diagram is where chlorite donor is added. Instead of a chemical pump, a venture could be inserted so that when water containing activating free halogen passes through, the venture draws in chlorite donor. When flow stops, so does the draw of chlorite. The chlorite donor draw rate can be proportioned to deliver the proper ratio of activating free halogen, optional oxidant and chlorite donor.

The cyclic process can be applied intermittently or continuously. When intermittent application of the cyclic process is employed, sustaining a presence of activating free halogen when chlorite anion is not present is optional. For example, in some applications it may be desirable to sustain a low level of free bromine in the open recirculating system 24/7 to maintain good microbiological control and prevent algae. Then in the evening hours, a dose of sodium chlorite is applied to initiate the cyclic process and further reduce the microbiological population.

During the implementation of the cyclic process, it may be advantageous to increase the concentration of activating free halogen. This can be accomplished using an ORP controller. When a chlorite donor is applied to the system, the ORP control detects it as a source of oxidant demand and the ORP is reduced. The ORP controller then initiates feed of free halogen to elevate the concentration of activating free halogen. As the concentration of chlorite anion slowly depletes from the aqueous solution, the ORP increases while the concentration of activating free halogen slowly reduces back to it pre-cyclic process concentration.

A similar method using ORP control can be used to operate a continuous cyclic process in hard to treat open recirculating systems. The control system can either periodically add small amounts of chlorite donor then sustain activating free halogen based off of sustaining ORP, or as ORP increases as a result of lower concentrations of chlorite donor, the controller can add small amounts of chlorite donor to again reduce the ORP, thereby initiating feed of free halogen.

Another option is to monitor the chlorine dioxide concentration using an on-line monitoring system exemplified by Cronos® and using an amperometric sensor with a gas permeable membrane (i.e. “Diosense M”). Both Cronos® and Diosense M are available through Process Instruments based in the UK.

Manual application of chemicals and field testing is also a viable option when periodic application of the cyclic process is suitable due to lower demands on the system.

The methods of application and process control are wide ranging and can be selected based on the on-site needs for that particular system.

### Processes and Compositions

### Example 1

To 1000 ml of tap water, 0.77 grams of sodium borate (i.e. borax) was added and mixed on a magnetic stirrer to achieve a pH of 9.32. While mixing, 300 μl of 1 wt % sodium bromide was added to provide approximately 2.3 ppm as bromide anion (Br—). 50 μl of 6 wt % sodium hypochlorite as added to provide approximately 3.0 ppm as Cl₂. An FAS-DPD test was performed and confirmed 3.4 ppm as Cl₂. 100 μl of 1.25 wt % as NaClO₂ was added while mixing to provide approximately 0.925 ppm as ClO₂⁻. The mixer was reduced to a slow stir.

After 40 minutes and 205 minutes samples were taken and a Palintest 7500 spectrophotometer was you to measure chlorine dioxide using lissamine green. The pH at the time of sampling was also recorded and shown in Table 1.

TABLE 1

| Lapsed Time (min) | pH | ClO₂ (mg/l) |
|---|---|---|
| 40 | 9.34 | 0.33 |
| 205 | 9.35 | 0.33 |

### Example 2

To 1000 ml of tap water, 0.77 grams of sodium borate (i.e. borax) was added and mixed on a magnetic stirrer to achieve a pH of 9.32. While mixing, 300 μl of 1 wt % potassium iodide was added to provide approximately 2.3 ppm as iodide anion (I⁻). 50 μl of 6 wt % sodium hypochlorite as added to provide approximately 3.0 ppm as Cl₂. An FAS-DPD test was performed and confirmed 3.2 ppm as Cl₂. 100 μl of 1.25 wt % as NaClO₂ was added while mixing to provide approximately 0.925 ppm as ClO₂. The mixer was reduced to a slow stir.

After 35 minutes and 185 minutes samples were taken and a Palintest 7500 spectrophotometer was you to measure chlorine dioxide using lissamine green. The pH at the time of sampling was also recorded as shown in Table 2.

TABLE 2

| Lapsed Time (min) | pH | ClO₂ (mg/l) |
|---|---|---|
| 35 | 9.37 | 0.37 |
| 185 | 9.38 | 0.36 |

### DISCUSSION OF EXAMPLES

Example 1 illustrates the ability to achieve in-situ generation of chlorine dioxide using a dilute solution of chlorite anions under alkaline pH conditions. In the example the pH was measured to be greater than 9.3 throughout the test.

Example 2 demonstrated under near identical conditions to example 1 that iodide can be converted to an activating free halogen to in-situ generate chlorine dioxide from chlorite anions under alkaline pH conditions.

### Advantages

It has been discovered that the cyclic process provides a means for in-situ generation of chlorine dioxide from dilute chlorite anion solutions under alkaline pH conditions that were believed to be detrimental to generating chlorine dioxide.

The cyclic process also provides for enhanced inactivation of microbiological organisms as a result of the reactivation of comparatively inert chlorite anions back into chlorine dioxide. For example when chlorine dioxide is reduced, approximately 85 percent is reduced back to chlorite anions. Using the cyclic process, over time the 85 percent of the chlorite is reactivated back to chlorine dioxide. This process repeats itself until the chlorite anion is effectively depleted.

To illustrate, beginning with 1.0 ppm as chlorite anion the cyclic process results in the following chlorine dioxide (reports as “ppm ClO₂”) equivalence: 1.0+0.85+0.72+0.61+0.52+0.44+0.37+0.32+0.27+0.23+0.19+0.16+0.14+0.12+0.10≥6.00 ppm as ClO₂ equivalence.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method for implementing the cyclic process to an open recirculating system to achieve enhanced inactivation of microbiological organisms under alkaline pH conditions, the method comprising:
flowing water through a system in fluid contact with the open recirculating system that produces an aqueous solution comprising an effective amount of activating free halogen and an effective amount of chlorite anions; and
passing the aqueous solution through a conduit to produce a chlorine dioxide solution;
applying the chlorine dioxide solution to the water in an open recirculating system,
wherein the water having a pH from about 8 to 10, and
wherein at least some portion of the chlorite anions resulting from the reduction of chlorine dioxide reacts with residual activating free halogen to in-situ generate chlorine dioxide resulting in enhanced inactivation of microbiological organisms.

2. The method in accordance with claim 1, wherein enhanced inactivation results in remediation of legionella.

3. The method in accordance with claim 1, wherein the water in the open recirculating system having a pH from about 8.5 to 10.

4. The method in accordance with claim 1, wherein an effective amount of an activating free halogen ranges from 0.2 ppm to 20 ppm reported as Cl₂.

5. The method in accordance with claim 1, wherein an effective amount of an activating free halogen ranges from 0.3 ppm to 10 ppm reported as Cl₂.

6. The method in accordance with claim 1, wherein an effective amount of an activating free halogen ranges from 0.4 ppm to 5 ppm reported as Cl₂.

7. The method in accordance with claim 1, wherein the effective amount of chlorite anion results in a concentration of chlorine dioxide between 0.1 ppm to 5 ppm reported as ClO₂.

8. The method in accordance with claim 1, wherein the activating free halogen is produced by reactions between a chlorinated isocyanurate and bromide salt.

9. The method in accordance with claim 1, wherein an effective amount of activating free halogen is achieved by applying Towerbrom® 90M.

10. The method in accordance with claim 1, wherein the effective amount of activating free halogen is achieved by applying Towerbrom® 60M.

11. A system for implementing the cyclic process to an open recirculating system to achieve enhanced inactivation of microbiological organisms under alkaline pH conditions, the system comprising:
flowing water through a conduit in fluid contact with a vessel containing a composition comprising a chlorinated isocyanurate and bromide salt to produce an aqueous solution having an effective amount of activating free halogen;
adding to said aqueous solution an effective amount of chlorite anions to produce a chlorine dioxide solution;
applying the chlorine dioxide solution to the water in an open recirculating system; the water having a pH from about 8 to 10; and
wherein at least some portion of the chlorite anions resulting from the reduction of chlorine dioxide reacts with residual activating free halogen to in-situ generate chlorine dioxide resulting in enhanced inactivation of microbiological organisms.

12. The method in accordance with claim 11, wherein enhanced inactivation results in remediation of legionella.

13. The method in accordance with claim 11, wherein the water in the open recirculating system having a pH from about 8.5 to 10.

14. The method in accordance with claim 11, wherein an effective amount of an activating free halogen ranges from 0.2 ppm to 20 ppm reported as Cl₂.

15. The method in accordance with claim 11, wherein an effective amount of an activating free halogen ranges from 0.3 ppm to 10 ppm reported as Cl₂.

16. The method in accordance with claim 11, wherein an effective amount of an activating free halogen ranges from 0.4 ppm to 5 ppm reported as Cl₂.

17. The method in accordance with claim 11, wherein the effective amount of chlorite anion results in a concentration of chlorine dioxide between 0.1 ppm to 5 ppm reported as ClO₂.

18. The method in accordance with claim 11, wherein the activating free halogen is produced by reactions between a chlorinated isocyanurate and bromide salt.

19. The method in accordance with claim 11, wherein an effective amount of activating free halogen is achieved by applying Towerbrom® 90M.

20. The method in accordance with claim 11, wherein the effective amount of activating free halogen is achieved by applying Towerbrom® 60M.

21. The system in accordance with claim 11, further comprising controlling the system feed rate using an ORP controller.

22. The system in accordance with claim 11, further comprising controlling the system feed rate using an chlorine dioxide controller.

23. The system in accordance with claim 11, further comprising controlling the system feed rate using a timer.

24. A method for implementing the cyclic process to an open recirculating system to achieve enhanced inactivation of microbiological organisms under alkaline pH conditions, the method comprising:
applying to the water of the open recirculating system an effective amount of activating free halogen and an effective amount of chlorite anions, the water having a pH from about 8 to 10;
the activating free halogen and chlorite anions react to in-situ generate chlorine dioxide, and
wherein at least a portion of the chlorite anions resulting from the reduction of chlorine dioxide reacts with residual activating free halogen to in-situ generate chlorine dioxide resulting in enhanced inactivation of microbiological organisms.

25. The method in accordance with claim 24, wherein enhanced inactivation results in remediation of legionella.

26. The method in accordance with claim 24, wherein the water in the open recirculating system having a pH from about 8.5 to 10.

27. The method in accordance with claim 24, wherein an effective amount of an activating free halogen ranges from 0.2 ppm to 20 ppm reported as Cl₂.

28. The method in accordance with claim 24, wherein an effective amount of an activating free halogen ranges from 0.3 ppm to 10 ppm reported as Cl₂.

29. The method in accordance with claim 24, wherein an effective amount of an activating free halogen ranges from 0.4 ppm to 5 ppm reported as Cl₂.

30. The method in accordance with claim 24, wherein the effective amount of chlorite anion results in a concentration of chlorine dioxide between 0.1 ppm to 5 ppm reported as ClO₂.

31. The method in accordance with claim 25, wherein the activating free halogen is produced by reactions between a chlorinated isocyanurate and bromide salt.

32. The method in accordance with claim 24, wherein an effective amount of activating free halogen is achieved by applying Towerbrom® 90M.

33. The method in accordance with claim 24, wherein the effective amount of activating free halogen is achieved by applying Towerbrom® 60M.

34. The method in accordance with claim 24, wherein the activating free halogen comprises iodine.
